(19) United States
(12) Patent Application Publication
(10) Pub. No.: US 2014/0238967 A1
(43) Pub. Date: Aug. 28, 2014

(54) HEATED MOVEABLE GLASS FOR VEHICLES

(71) Applicant: SPARTAN MOTORS, INC., Charlotte, MI (US)

(72) Inventors: Ian W. BOYCE, Olivet, MI (US); Todd E. Chapman, Olivet, MI (US); Steven R. Siler, Charlotte, MI (US)

(73) Assignee: SPARTAN MOTORS, INC., Charlotte, MI (US)

(21) Appl. No.: 13/777,437

(22) Filed: Feb. 26, 2013

(51) Int. Cl. H05B 3/84; B60L 1/02

(52) U.S. Cl. CPC H05B 3/84; B60L 1/02
USPC 219/203

(57) ABSTRACT

A device comprises a vehicle frame portion; a vehicle window that is selectively movable relative to the vehicle frame portion between a open position and a closed position, the vehicle window comprising at least one conductive heating element; and at least one flexible electrical supply cord. A first portion of the at least one flexible electrical supply cord is attached to the vehicle window. A second portion of the at least one flexible electrical supply cord is attached to the vehicle frame portion. The at least one flexible electrical supply cord is configured to conductively connect the at least one conductive heating element to a vehicle electrical bus when the vehicle window is in the open position and when the vehicle window is in the closed position.

### BACKGROUND

The present invention relates generally to the field of vehicle windows. More specifically, the present invention relates to movable vehicle windows that are configured to be heated.

The dew point is the temperature at which the water vapor in the air condenses and, at a constant pressure, is directly proportional to the amount of moisture in the air. The dew point cannot exceed the temperature and warmer air is able to contain more water vapor than colder air. In a situation where there is a substantial difference in temperature between a colder object and the warmer surrounding air, water vapor may condense on the cold object due to localized cooling of the air to the dew point. Such a situation is common on automobile windows, especially in colder climates, where the exterior air cools a vehicle's windows below the interior temperature of the vehicle. If there is enough water vapor in the interior air, it may condense on the windows, causing them to fog up.

Several techniques are known to “defog” the interior of a vehicle window by causing the condensation to evaporate, including directing heated air onto the glass to warm it. However such directed air systems require additional ducting for the vehicle's HVAC system. Additionally, the blowers used to direct the air at the windows add additional load to the vehicle's electrical system and add noise and vibrations.

### SUMMARY

In one embodiment, a device comprises a vehicle frame portion; a vehicle window that is selectively movable relative to the vehicle frame portion between a open position and a closed position, the vehicle window comprising at least one conductive heating element; and at least one flexible electrical supply cord. A first portion of the at least one flexible electrical supply cord is attached to the vehicle window. A second portion of the at least one flexible electrical supply cord is attached to the vehicle frame portion. The at least one flexible electrical supply cord is configured to conductively connect the at least one conductive heating element to a vehicle electrical bus when the vehicle window is in the open position and when the vehicle window is in the closed position.

In one aspect, the vehicle frame portion is a vehicle door frame.

In one aspect, the at least one flexible electrical supply cord is conductively connected to the at least one conductive heating element via at least one bus bar.

In one aspect, the first portion of the at least one flexible electrical supply cord is attached to the vehicle window via a bracket.

In one aspect, the second portion of the at least one flexible electrical supply cord is attached to the vehicle frame portion via a bracket.

In one aspect, the first portion of the at least one flexible electrical supply cord is attached to the vehicle window via a first bracket, and the second portion of the at least one flexible electrical supply cord is attached to the vehicle frame portion via a second bracket.

In one aspect, the device further comprises a wire carrier disposed around the at least one flexible electrical supply cord in a section of the at least one flexible electrical supply cord located between the first portion and the second portion.

In one aspect, the wire carrier is an articulated wire carrier.

In one aspect, the wire carrier is an articulated wire carrier comprising a plurality of hinged segments.

In one aspect, a first end of the articulated wire carrier is attached to the vehicle window via a first bracket, and wherein a second end of the articulated wire carrier is attached to the vehicle window via a second bracket.

In one aspect, the wire carrier is configured such that at least some slack remains in the wire carrier when the vehicle window is in the open position.

In one aspect, the at least one flexible electrical supply cord is configured such that at least some slack remains in the at least one flexible electrical supply cord when the vehicle window is in the open position.

In one aspect, the device further comprises at least one stress relief member attached to the vehicle window, wherein wires of the at least one flexible electrical supply cord are coupled to the at least one stress relief member.

In one aspect, the at least one flexible electrical supply cord has a coiled section.

In one aspect, the coiled section is located between the first portion and the second portion.

In one aspect, the coiled section is configured to be in an expanded state when the vehicle window is in a open position, and the coiled section is configured to be in a contracted state when the vehicle window is in a closed position.

In one aspect, at least a portion of the at least one flexible electrical supply cord is a part of an electrical wiring harness.

In another embodiment, a device comprises a vehicle frame portion; a vehicle window that is selectively movable relative to the vehicle frame portion between a open position and a closed position, the vehicle window comprising at least one conductive heating element; and means for conductively connecting the at least one conductive heating element to a vehicle electrical bus when the vehicle window is in the open position and when the vehicle window is in the closed position.

In another embodiment, a vehicle comprises a vehicle frame portion; a vehicle window that is selectively movable relative to the vehicle frame portion between a open position and a closed position, the vehicle window comprising at least one conductive heating element; and at least one flexible electrical supply cord. A first portion of the at least one flexible electrical supply cord is attached to the vehicle window. A second portion of the at least one flexible electrical supply cord is attached to the vehicle frame portion. The at least one flexible electrical supply cord is configured to conductively connect the at least one conductive heating element to a vehicle electrical bus when the vehicle window is in the open position and when the vehicle window is in the closed position.

In one aspect, the vehicle frame portion is a vehicle door frame.

### BRIEF DESCRIPTION OF THE DRAWINGS

Features, aspects, and advantages of embodiments of the present invention will become apparent from the following description and the accompanying exemplary embodiments shown in the drawings, which are briefly described below.

FIG. 1 is a schematic side view of a vehicle including a moveable heated glass window, in accordance with an exemplary embodiment.

FIG. 2 is an isometric view of a door for the vehicle of FIG. 1 having a moveable heated glass window in an open position, in accordance with an exemplary embodiment.

FIG. 3 is an isometric view of a door for the vehicle of FIG. 1 having a moveable heated glass window in a closed position, in accordance with an exemplary embodiment.

FIG. 4 is a detail isometric view of the lower portion of the moveable heated glass window of FIG. 2, in accordance with an exemplary embodiment.

FIG. 5 is a side elevation view of a door for the vehicle of FIG. 1 having a moveable heated glass window in a closed position, in accordance with another exemplary embodiment.

FIG. 6 is a side elevation view of the defogging system for moveable heated glass window FIG. 5, in accordance with an exemplary embodiment.

FIG. 7 is a detail view of the defogging system of FIG. 6, showing the embedded heating elements.

FIG. 8 is a detail view of the defogging system of FIG. 6, showing the upper mounting bracket for the wire carrier.

FIG. 9 is a detail view of the defogging system of FIG. 6, showing the lower mounting bracket for the wire carrier.

### DETAILED DESCRIPTION

One embodiment of the invention relates to defogging system for a moveable window including a multitude of conductive heating elements on a window for a vehicle, the window moveable in a linear direction between an open position and a close position; terminals conductively coupled to the conductive heating elements; and an electrical supply cord coupling the terminals to a vehicle electrical bus. The electrical supply cord is flexible such that it may move as the window moves between the open position and the closed position.

It is to be understood that the following detailed description is exemplary and explanatory only, and is not restrictive of the invention.

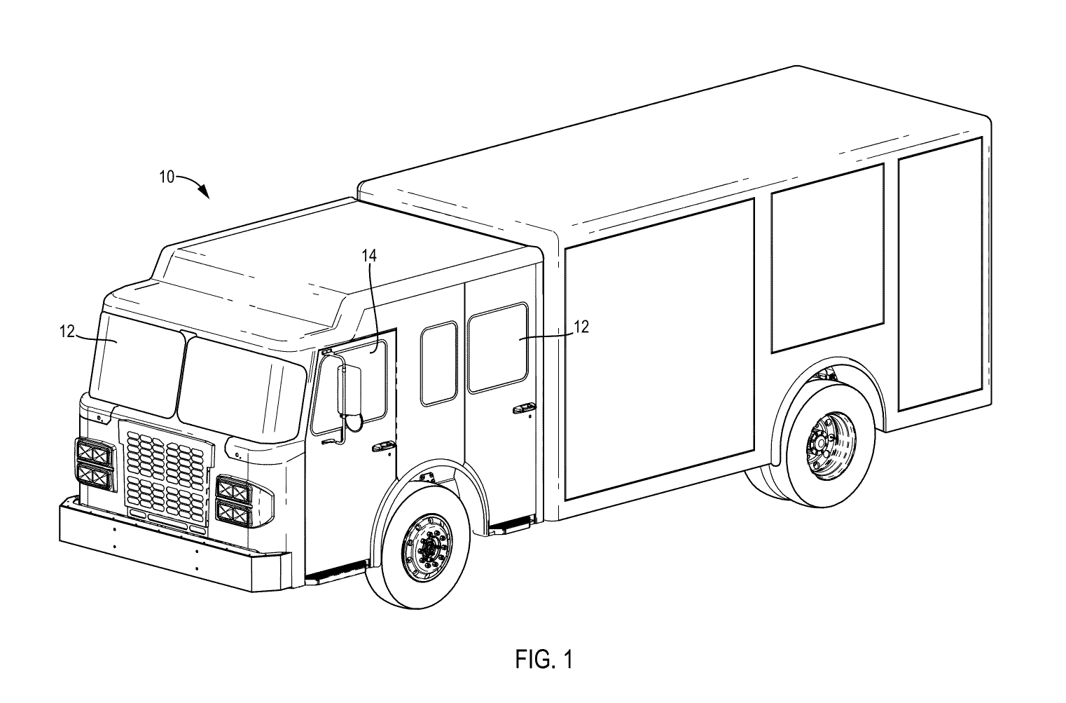

Referring to FIG. 1, a vehicle 10 is shown according to an exemplary embodiment. The vehicle 10 may be, for example, an ambulance, a fire engine, a tow truck or any other emergency or utility vehicle. In other embodiments, the vehicle 10 may be a civilian vehicle, such as an automobile, a truck, a van, a sport utility vehicle, a crossover vehicle, etc. In still other embodiments, the vehicle may be another type of vehicle, such as a military vehicle, construction vehicle, delivery vehicle, or a mass transport vehicle (e.g., train, bus, etc.). The vehicle 10 includes a multitude of windows including both fixed glass windows 12 (e.g., windshield, rear window, fixed side windows, etc.) and movable glass windows 14.

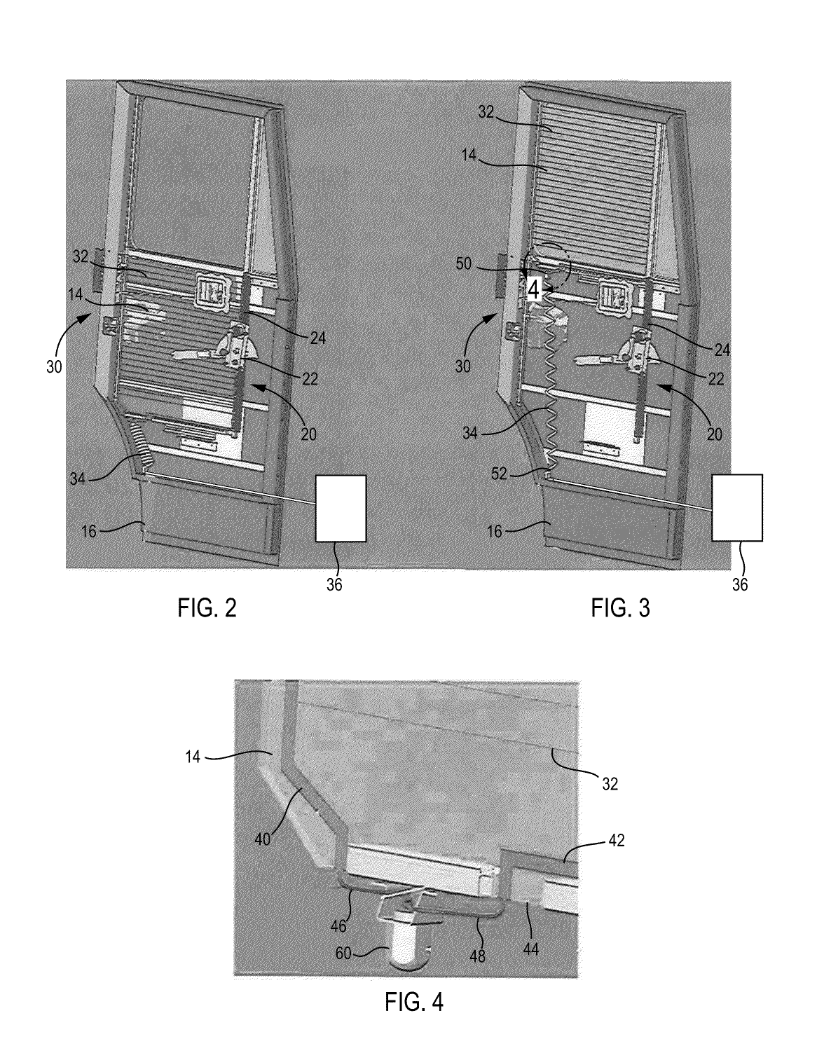

The moveable windows 14 are configured to be moved up and down using either a manual actuator (e.g., a hand crank) or a powered actuator (e.g., an electric motor). According to an exemplary embodiment, the vehicle 10 includes moveable windows 14 disposed in the upper portion of door frames 16, shown in FIGS. 2 and 3. The moveable window 14 is actuated between an open or lowered position (FIG. 2) and a closed or raised position (FIG. 3) with a regulator 20. While vertically sliding windows are shown in the Figures, the window need not be a vertically sliding window. Rather, the window can slide in any direction, including both vertically or horizontally. According to an exemplary embodiment, the regulator 20 is a power cable-type regulator and includes an electric motor 22 coupled to a cable. The cable, in turn, is coupled to the moveable window 14 and moves the window 14 along tracks 24. While the window 14 is shown to be disposed in a door frame 16, the window may disposed in any other part of a vehicle frame portion such as, for example, a vehicle side wall.

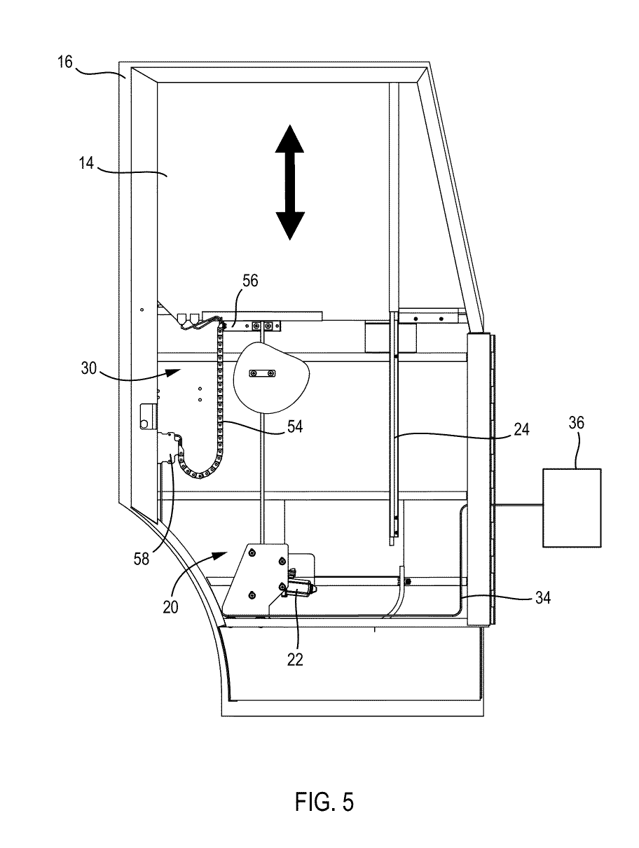

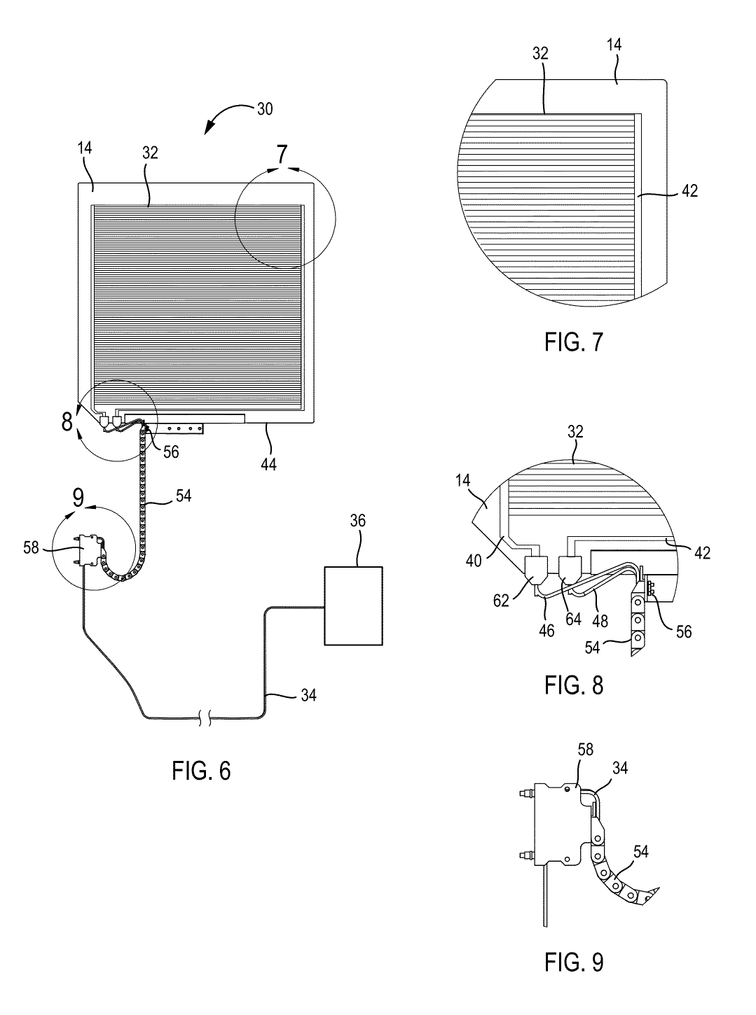

During the operation of the vehicle 10, moisture levels of the air in the interior of the vehicle may become elevated. This moisture may condense on the inner surface of the windows if a there is a sufficient temperature gradient between the interior of the vehicle and the exterior of the vehicle. A defogging mechanism 30 (e.g., defrosting mechanism) is provided to increase the temperature of the moveable window 14 and evaporate moisture in the form of condensation or frost that has collected on the inside surface of the moveable window 14. The defogging mechanism 30 is shown according to one exemplary embodiment in FIGS. 2-4 and another embodiment in FIGS. 5-9. The inner panel of the door frame 16 is removed in FIGS. 2-5 to show the internal components of the door frame 16. According to an exemplary embodiment, the defogging mechanism 30 includes one or more heating elements 32 coupled to the window 14 and a flexible electrical supply cord 34 coupling the heating elements 32 to the vehicle electrical bus 36 to provide power to the heating elements 32.

The heating elements 32 are a multitude of parallel conductive wires embedded in the movable window 14 (e.g., provided between layers of a laminated glass), as shown, for example, in FIGS. 3 and 7. According to an exemplary embodiment, the heating elements 32 are tungsten wires extending generally horizontally from one side of the moveable window 14 to the opposite side. The heating elements 32 may be straight or otherwise shaped (e.g., curved, sinusoidal, etc.). The heating elements 32 are spaced apart far enough that the overall density of heating elements 32 in the moveable window 14 minimally effect the view of an occupant of the vehicle 10 through the moveable window 14. According to an exemplary embodiment, the heating elements 32 reduce the light transmission through the moveable window 14 by less than 5%.

The heating elements 32 are conductively coupled on one end to a first bus bar 40 and on the opposite end to a second bus bar 42. The bus bars 40 and 42 extend vertically along the sides of the moveable window 14. The bus bars 40 and 42 may be embedded in the moveable window 14 like the heating elements 32 or may be disposed on the surface or edges of the moveable window 14.

Referring now to FIGS. 4 and 8, the bus bars 40 and 42 extend downward to the lower edge 44 of the moveable window 14. The terminal ends of the bus bars 40 and 42 are conductively coupled to the electrical supply cord 34. According to an exemplary embodiment, the defogging mechanism 30 is a DC system the bus bars 40 and 42 are coupled to the positive wire 46 and the negative wire 48 of the supply cord 34, respectively. The connections between the bus bars 40 and 42 and the wires 46 and 48 may be any suitable connection that creates a mechanical and conductive coupling. For example, the wires 46 and 48 may be soldered directly to the bus bars 40 and 42 or may be connected via a male/female connector. The opposite ends of the wires 46 and 48 are conductively coupled (though not necessarily directly coupled) to the vehicle electrical bus 36. The wires 46 and 48 may be part of a collected wiring harness for the door including electrical supply wires for other systems (e.g., the regulator 20, an electric lock system, lights, etc.).

The electrical supply cord 34 is configured to be flexible such that it may remain mechanically coupled to both the moveable window 14 and to the door frame 16, to provide electrical power to the heating elements 32 through the entire range of positions between the open position and the closed position.

As shown in FIGS. 2-4, in one embodiment, the electrical supply cord 34 may be a coil cord with a first end 50 mechanically coupled to the moveable window 14. For example, the first portion 50 of the electrical supply cord 34 may be mechanically coupled to the moveable window 14 at a lower edge 44 of the moveable window. The coupling may be through the coupling of the electrical supply wires 46 and 48 to the bus bars 40 and 42. A second portion 52 of the electrical supply cord 34 may be coupled to the door frame 16. For example, the second portion 52 of the electrical supply cord 34 may be coupled to a lower portion of the door frame 16. With the moveable window 14 in the closed position (FIG. 2), the electrical supply cord contracts, with the first portion 50 proximate the second portion 52. As the moveable window is moved upward to the closed position (FIG. 3), the first portion 50 is pulled away from the second portion 52, extending at least a section of the electrical supply cord 34. The first portion may be at a first end of the electrical supply cord 34. The second portion 52 may be at a second end of the electrical supply cord 34, opposite the first end. Where the second portion 52 is at the second end of the electrical supply cord 34, a separate cord may conductively connect the second portion 52 of the electrical supply cord 34 to the vehicle electrical bus 36. Alternatively, the electrical supply cord 34 may extend all the way from the bus bars 40 and 42 to the vehicle electrical bus 36, with only a portion of the electrical supply being coiled. For example, only the portion of the electrical supply cord 34 between the mechanical coupling to the moveable window 14 and the mechanical coupling to the door frame 16 may be coiled. Of course, any number of additional conductive wires may be located between the electrical supply cord 34 and the vehicle electrical bus 36.

As shown in FIGS. 5-9, in another embodiment, the electrical supply cord 34 may be provided within a wire carrier 54. The wire carrier 54 may be a feed-through wire carrier, as shown in FIGS. 5-9. The wire carrier 54 may be an articulated wire carrier. For example, the wire carrier 54 may include a plurality of hinged segments. The carrier 54 is coupled to the moveable window 14 via an upper bracket 56 (FIG. 8), and is coupled to the lower portion of the door frame 16 via a lower bracket 58 (FIG. 9). When the moveable window 14 is in its uppermost, closed position, the carrier 54 and the electrical supply cord 34 are not pulled taut, but are instead slack. The slack nature of the carrier 54 and the electrical supply cord 34, along with the rigid coupling of the carrier 54 to the moveable window 14 via the upper bracket 56 and to the door frame 16 via the lower bracket 58 minimizes the forces applied to the electrical supply cord 34. The forces and the resulting stresses are therefore directed around the cord 34 and to the moveable window 14 and the door frame 16.

Referring to FIG. 4, in one exemplary embodiment, a stress relief member 60 (e.g., bracket, clamp, collar, etc.) is provided proximate the first end 50 of the electrical supply cord 34. The stress relief member 60 is rigidly coupled to the moveable window 14 and the wires 46 and 48 are coupled to the stress relief member 60 such that the end portions of the wires 46 and 48 are isolated from any forces applied to the remainder of the electrical supply cord 34. The forces applied to the connections between the bus bars 40 and 42 and the wires 46 and 48 are minimized. Referring to FIG. 8, in another exemplary embodiment, the ends of the wires 46 and 48 may each include separate stress relief members 62 and 64 configured to reduce the force applied to the ends of the wires 46 and 48.

The construction and arrangement of the elements of the movable heated vehicle glass as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. Some like components have been described in the present disclosure using the same reference numerals in different figures. This should not be construed as an implication that these components are identical in all embodiments; various modifications may be made in various different embodiments. It should be noted that the elements and/or assemblies of the enclosure may be constructed from any of a wide variety of materials that provide sufficient strength or durability, in any of a wide variety of colors, textures, and combinations.

What is claimed is:

1. A device comprising:
a vehicle frame portion;
a vehicle window that is selectively movable relative to the vehicle frame portion between a open position and a closed position, the vehicle window comprising at least one conductive heating element; and
at least one flexible electrical supply cord,
wherein a first portion of the at least one flexible electrical supply cord is attached to the vehicle window,
wherein a second portion of the at least one flexible electrical supply cord is attached to the vehicle frame portion, and
wherein the at least one flexible electrical supply cord is configured to conductively connect the at least one conductive heating element to a vehicle electrical bus when the vehicle window is in the open position and when the vehicle window is in the closed position.

2. The device of claim 1, wherein the vehicle frame portion is a vehicle door frame.

3. The device of claim 1, wherein the at least one flexible electrical supply cord is conductively connected to the at least one conductive heating element via at least one bus bar.

4. The device of claim 1, wherein the first portion of the at least one flexible electrical supply cord is attached to the vehicle window via a bracket.

5. The device of claim 1, wherein the second portion of the at least one flexible electrical supply cord is attached to the vehicle frame portion via a bracket.

6. The device of claim 1, wherein the first portion of the at least one flexible electrical supply cord is attached to the vehicle window via a first bracket, and wherein the second portion of the at least one flexible electrical supply cord is attached to the vehicle frame portion via a second bracket.

7. The device of claim 1, further comprising a wire carrier disposed around the at least one flexible electrical supply cord in a section of the at least one flexible electrical supply cord located between the first portion and the second portion.

8. The device of claim 7, wherein the wire carrier is an articulated wire carrier.

9. The device of claim 7, wherein the wire carrier is an articulated wire carrier comprising a plurality of hinged segments.

10. The device of claim 7, wherein a first end of the articulated wire carrier is attached to the vehicle window via a first bracket, and wherein a second end of the articulated wire carrier is attached to the vehicle window via a second bracket.

11. The device of claim 7, wherein the wire carrier is configured such that at least some slack remains in the wire carrier when the vehicle window is in the open position.

12. The device of claim 1, wherein the at least one flexible electrical supply cord is configured such that at least some slack remains in the at least one flexible electrical supply cord when the vehicle window is in the open position.

13. The device of claim 1, further comprising at least one stress relief member attached to the vehicle window, wherein wires of the at least one flexible electrical supply cord are coupled to the at least one stress relief member.

14. The device of claim 1, wherein the at least one flexible electrical supply cord has a coiled section.

15. The device of claim 12, wherein the coiled section is located between the first portion and the second portion.

16. The device of claim 12, wherein the coiled section is configured to be in an expanded state when the vehicle window is in a open position, and wherein the coiled section is configured to be in a contracted state when the vehicle window is in a closed position.

17. The device of claim 1, wherein at least a portion of the at least one flexible electrical supply cord is a part of an electrical wiring harness.

18. A device comprising:
a vehicle frame portion;
a vehicle window that is selectively movable relative to the vehicle frame portion between a open position and a closed position, the vehicle window comprising at least one conductive heating element; and
means for conductively connecting the at least one conductive heating element to a vehicle electrical bus when the vehicle window is in the open position and when the vehicle window is in the closed position.

19. A vehicle comprising:
a vehicle frame portion;
a vehicle window that is selectively movable relative to the vehicle frame portion between a open position and a closed position, the vehicle window comprising at least one conductive heating element; and
at least one flexible electrical supply cord,
wherein a first portion of the at least one flexible electrical supply cord is attached to the vehicle window,
wherein a second portion of the at least one flexible electrical supply cord is attached to the vehicle frame portion, and
wherein the at least one flexible electrical supply cord is configured to conductively connect the at least one conductive heating element to a vehicle electrical bus when the vehicle window is in the open position and when the vehicle window is in the closed position.

20. The vehicle of claim 19, wherein the vehicle frame portion is a vehicle door frame.
